(19) United States
(12) Patent Application Publication
(10) Pub. No.: US 2016/0074865 A1
(43) Pub. Date: Mar. 17, 2016

(54) SYSTEM AND METHOD OF MARKING ARTICLES COATED WITH A LASER-SENSITIVE MATERIAL

(71) Applicant: California Advanced Labeling, Inc., Fremont, CA (US)

(72) Inventors: Nagasatish Rao, Fremont, CA (US); Quoc Duong, Fremont, CA (US)

(21) Appl. No.: 14/843,301

(22) Filed: Sep. 2, 2015

Related U.S. Application Data
(60) Provisional application No. 62/048,844, filed on Sep. 11, 2014.
(60) Provisional application No. 62/048,847, filed on Sep. 11, 2014.

(51) Int. Cl. B01L 3/00; F16L 9/14; B41M 5/26

(52) U.S. Cl. CPC B01L 3/5453; B41M 5/267; F16L 9/14; B01L 2300/0851

(57) ABSTRACT

A method for uniquely identifying tubes may include programming a motion of a laser relative to a tube pad printed with a mixture of ink and a laser sensitive material and exposing the laser-sensitive material to the laser to colorimetrically transform the material and reveal a unique identifier. A method of coating tubes includes plasma or flame treating the tube and mixing a laser-sensitive material with ink to form a mixture to pad print onto the tube. A system for identifying tubes coated with laser-sensitive material includes a laser mounted in translational relationship to a stage, a camera positioned to capture an image of a tube on a stage, a processor that receives the image and translates the laser relative to the stage in order to position the laser for marking the tube, and a laser controller to move the laser in order to mark the tube.

### CROSS-REFERENCE TO RELATED APPLICATIONS

This application claims the benefit of the following provisional applications, each of which is hereby incorporated by reference in its entirety:

U.S. Non-Provisional Application No. 62/048,844, filed Sep. 11, 2014; and U.S. Non-Provisional Application No. 62/048,847, filed Sep. 11, 2014.

### BACKGROUND

1. Field

This disclosure relates to systems and methods for marking three-dimensional surfaces coated or doped with a laser-sensitive material.

2. Description of the Related Art

Various methods and systems currently exist to mark the surface of tubes or vials (the terms are interchangeable and any reference herein to one, refers to both) or other objects or articles, with various advantages and disadvantages. Examples of some of such methods will be described herein, but it should be noted that some of these examples are not generally used in the life sciences field.

Manual marking using a marker or pen may be inexpensive, easy to use, and may be done on a variety of types of tube. However, it also may be laborious, may be prone to human error, may be inconsistent, and may not be able to accommodate barcodes effectively. Printing flat adhesive labels on standard computer printers or thermal transfer printers and hand-applying them to objects may be inexpensive, may be easy to use, and may be done on a variety of tubes. However, the process of applying the labels may be laborious and may be inconsistently placed on the object and/or prone to error. Furthermore, labels made of adhesive glue can possibly fall away from a vial when presented with extreme cold or hot environments or when aggressive solvents are applied. Heat shrink tubes may also be laborious to produce and apply. Factory marking may require less labor and may be automation-equipment friendly, however the factory marking option may be more costly and more limited in customizability. Plastic inserts, which may be fitted into separate tubes, may be relatively inexpensive but, in some circumstances, a separate piece of marked plastic must be hand-assembled and may only be available for select tubes, such as cryovials. Direct thermal transfer on the surface of the article may have better solvent resistance, but may be available only for selected articles, such as glass HPLC (chromatography) vials, slides and histology cassettes whose geometry is directly tied to the method for bringing the thermal ribbon to the object to transfer the thermal ink. Any variation in such geometry from manufacturer to manufacturer can cause issues with the loading mechanism. Furthermore, the rigidity of the object must be within a specific tolerance in order to exert sufficient normal force on the ribbon apparatus. Direct thermal transfer also may be relatively expensive and slow due to the use of ribbons. Automated adhesive label appliers may require relatively little labor and may be applicable to a variety of tubes, however, such equipment may be relatively expensive, tube-specific, slow, and may be prone to jamming when the labeled tube is placed into secondary equipment.

Automated laboratory markers, such as, for example, the “TubeWriter Standard” machine (California Advanced Labeling, Inc.; Fremont, Calif.) may offer relatively inexpensive dynamic printing on any tube but may provide relatively lower throughput. A tube printing machine, for example, may automate the movement of a lab marker to print directly on a variety of tubes using, for example, Microsoft Excel® or another data source. An example of a user interface operable with this machine, which may also be an example of a user interface potentially operable with the laser marking system of this disclosure, is depicted in FIG. 6. Ink jet printing, such as may be provided by the “TubeWriter 360” system (California Advanced Labeling, Inc.; Fremont, Calif.) may offer dynamic printing on a variety of tubes as well as barcode printing but may not be as resistant to formaldehydes and acetone-based solvents as factory methods.

Lasers making ablative marks on applied opaque patches or directly onto plastic or glass may provide low contrast, and, in certain cases, under potentially unsafe conditions due to the high-powered laser required to remove or ablate material rather than simply excite it. Ablating refers to a process whereby a patch 1102, typically white, is selectively removed by a laser beam 1100, such as depicted in FIG. 11. The resultant mark is the plastic's 1104 natural color, usually clear, against the white background, and the process may involve bits 1108, such as bits of patch and/or plastic, being ejected or burnt during ablation. The application of such an opaque patch may be difficult on a curved surface. In embodiments, multiple layers of material may need to be applied to tubes for laser ablation. Two plies of material may require a relatively complicated manufacturing process and a relatively high-powered and accurate laser to ablate the first layer without damaging the second layer, which may make a field-use customer laser more difficult. U.S. Pat. No. 6,372,293 and United States Patent Application 2002/0106309 to Matrix Technologies Corporation (Hudson, N.H.) may provide a 2-ply light-dark polymer for marking on the bottoms of cluster tubes.

In embodiments, tubes may be doped with laser sensitive material. For example, a bottom layer may be transparent and may be doped and the next layer may be opaque. The laser may hit the transparent layer and produce a color change different than the next layer. Such a technique may require a multi-step molding process (over-molding or assembly of two plastic parts), which can raise the cost of the vials. In addition, the laser may interact with the base plastic material of the tube, in addition to reacting to the laser-sensitive additive, which may cause the emission of hazardous fumes. For example, United States Patent Application 2011/0308335 to Nexus Biosystems may dope the plastic material comprising the bottom of the original tube.

Another way to mark the surface of tubes or other laboratory items is by marking the walls of syringes by removing material from the body of the syringes, such as provided by U.S. Pat. No. 7,856,795 to Becton, Dickinson, and Company (Franklin Lakes, N.J.).

An option may be to use a secondary plastic piece that acts like a “jacket” around the tube. A tube jacket may be, for example, a plastic mold on which a laser directly produces a color change to white. The laser may possibly be a YAG laser.

Another example of marked laboratory tubes includes well format polypropylene tubes with a laser etched 2D barcode on a base or jacket of the tube, such as provided by FluidX (Cheshire, UK).

Another example of marked laboratory tubes includes light dot codes formed by laser burning on an opaque background on the bottom of a tube, such as provided by U.S. Pat. No. 6,270,728 to Micronic.

While tubes and other liquid receptacles in use in the life sciences will be used as exemplary throughout this specification, it should be understood that this disclosure relates to any three dimensional surface of an article that can be coated, doped or filmed (mechanically or adhesively) with the laser-sensitive materials and marked thereafter with a laser or other coherent light source.

The “Life Sciences” area is generally considered to be a set of fields studying living organisms. The Life Sciences area includes almost anything “wet”. This includes the clinical area (diagnosis, testing and treatment of disease), research (molecular, cellular, tissue, organism level discovery of the causes of biological conditions), and development (testing of drugs, testing of tests). Life science can be conducted in an academic, government or private setting. The fields of study range from chemistry, to biochemistry, to medicine. In fields where liquids are utilized, such as the life sciences, medicine, public health, and the like, receptacles for liquids may need to be marked to identify the liquids contained therein. For example, solutions may be held in cylindrical plastic or glass vials or tubes which range in size from about 4 mm outer diameter (OD)/10 mm length up to 100 mm OD/300 mm length. A typical tube may be around 10 mm OD/30 mm length, made from virgin polypropylene, may hold 2 mL of solution, and may have a cap to prevent leakage. In certain applications, tubes must withstand extreme temperature environments (−196° C. in liquid nitrogen storage, for example, to 100° C.) and harsh solvent environments (ethanol and ketones are widely used). In other applications, tubes must be constructed with very exacting tolerances to (1) prevent leakage by surfaces matching edges; (2) allow for a variety of third-party secondary equipment, such as automated fillers or centrifuges, to accept thousands of tubes; (3) allow for fully-automated robotic solutions to grip and grab the tubes. The form factor, material and size of the tube depend not only on the material held therein and application of particular tests, but also to the life cycle of the tube. Some tubes hold their contents for a short period of time, such as one daily experiment and are then discarded, while other tubes store their contents for years or decades and must be easily accessible and retrievable those years later without any damage to the contents. Some tubes hold molecular liquid solutions, while others contain tissue.

Other than purely chemical processes involving expensive, large glass flasks, vials generally are not re-used. Vials typically are either stored for years, or used once and discarded. In either case, experiments or tests may involve hundreds to thousands of vials, while organizations may use tens of thousands to millions of vials. Because each vial (a) has virtually the same form factor; (b) contains a solution which is indistinguishable to the human eye in most cases; and (c) is of great value to the researcher or testing facility, a method of uniquely identifying each vial is needed. Further, accuracy may also be desired.

Identification may consist of some sort of unique but serializable identifier. For example, in an experiment consisting of 100 samples, a one- to three-digit serial number may identify the samples. But in cases where the samples are stored, having more than one tube with the same identifier can cause significant issues. This uniqueness may range from uniqueness simply across the experiment, such that no two tubes in the experiment have the same identifier, to uniqueness across the lab's storage facility, to uniqueness across the organizations storage facilities, to ultimately uniqueness across all tubes from that manufacturer wherever in the world.

Therefore, a need exists for a system and method of providing unique identifiers for any kind of tube or item with a curved surface, optionally in addition to other information such as temperature warning instructions or date of creation, that exhibits high resolution, high solvent resistance, and ease of customization.

### SUMMARY

The combination of pad printing, or tampography of, curved surfaces of items with a laser-sensitive, color-changing material may be advantageous as an alternative to applying laser-sensitive material with an adhesive (which may tear or become wet and relatively illegible under harsh conditions, or may cause the items to not fit satisfactorily in tight tolerance machines) or by doping the item itself at what may be a relatively high cost, or may allow for the use of such alternative options to be reduced to a more desirable level. Further, a laser-sensitive, color changing material for pad printing may be an advantageous alternative to the use of a high-powered laser to ablate non-laser sensitive materials (or allow such use to be minimized to a more desirable level). Since color-changing materials generally do not have to be ablated, lower power lasers may be used in the systems and methods described herein.

In an aspect, a method for uniquely identifying tubes may include programming relative motion (i.e. either the laser beam moves and the tubes are stationary, or there is a fixed laser beam which can be pulsed and individual tubes trace the pattern of a mark by their own movement) of a laser beam to correspond to an identifier to be laser-marked onto a tube, wherein the tube has a coating, doping, film or separately adhered insert (e.g. adhered mechanically or adhesively) including a mixture of ink and a laser-sensitive material and exposing the laser-sensitive material to the laser to transform the material from one color to another, wherein the transformation of the material reveals the identifier. The printing technique may be pad printing.

In an aspect, a method of coating tubes to be uniquely identified may include mixing a laser-sensitive material with an ink to form a mixture, plasma or flame treating the tube, and applying the mixture onto the tube. The printing technique may be pad printing.

In an aspect, a method for identifying tubes may include pad printing a tube with a mixture of ink and a laser sensitive material, programming a laser with an identifier for each tube, and exposing the laser-sensitive material to the laser to transform the laser-sensitive material from one color to another, wherein the transformation of the material reveals the identifier. The mixture may be 50/50 pad print ink and laser-sensitive material. The laser may be a CO₂ laser.

In an aspect, a method for identifying tubes may include pad printing a tube with a mixture of ink and a laser sensitive material, mounting a laser in translational relationship to a stage, and translating at least one of the laser, a laser beam, and the stage relative to the others and in accordance with an identifier for each tube in order to transform the laser-sensitive material from one color to another, wherein the transformation of the material reveals the identifier. The tubes may be placed into racks on the stage, wherein the racks normalize the height of the tubes relative to a standard so that the patch is presented at the same distance from the laser regardless of the geometry of the tube. The tubes may lay at least one of horizontally or vertically in the rack.

In an aspect, a method for identifying tubes may include screen printing a tube with a mixture of ink and a laser sensitive material, programming a laser with an identifier for each tube, and exposing the laser-sensitive material to the laser to transform the laser-sensitive material from one color to another, wherein the transformation of the material reveals the identifier.

In an aspect, a system for uniquely identifying items with at least one curved surface may include a laser mounted in translational relationship to a stage, a processor that receives information about placement of the item on the stage and translates the laser, laser beam or stage relative to the others in order to position the laser for marking the item, and a laser controller to move the laser, the laser beam, or the stage in accordance with data from a data source in order to effect a color change of a pad-printed, laser-sensitive material on the curved surface of the item. The items may include a patch of printed ink mixed with a laser-sensitive material. The items may be presented to the laser either by a picker individually moving tubes, or by the tubes being laid vertically or horizontally on a surface. The items may be placed into racks on the stage, where they can lay horizontally or vertically, and wherein the racks normalize the height of the items relative to a standard so that the patch is presented at the same distance from the laser regardless of the geometry of the tube. In the either case, the marking may be made by movement of the laser, movement of the laser beam, or movement of the items, by either the stage or the picking arm. The printing technique may be pad printing. The information may be received from a camera positioned along the same axis as the laser. The camera may be positioned to capture an image of the item placed on the stage. The camera may image a marker on the item that provides location information for where exactly the patch of pad print ink is on the item. The laser-sensitive material may be mixed with an ink. The item may include an ultrasonic welded film comprising ink mixed with a laser-sensitive material. The item may be a tube. The system may further include a gripper system for grabbing items to be held vertically and bringing them to the laser one by one. The gripper system rotates the items while lasering.

In an aspect, a process for preparing a laser-marked tube may include at least one of corona-, plasma- or flame-treating a tube, pad printing a mixture of ink and laser-sensitive material onto the tube using a pad printer to form a coating, at least one of allowing the coating to air dry, oven dry, and UV curing the coating. The process may further include presenting the coated tubes to a laser marking system that may include application software that may instruct a laser to excite the laser-sensitive material in order to place data/information on the tubes. The mixture may be, for example, 50%/50% by volume pad print ink and laser-sensitive material. The tubes may be molded or blown.

In an aspect, a process for preparing a laser-marked tube may include molding a tube, at least one of corona-, plasma- or flame-treating the molded tube, pad printing a mixture of ink and laser-sensitive material onto the tube using a pad printer to form a coating, at least one of allowing the coating to air dry, oven drying, and UV curing the coating, and presenting the coated tubes to a laser marking system at either the factory or customer site that includes application software that instructs a laser to excite the laser-sensitive material in order to place data on the tubes. The mixture may be, for example, 50%/50% by volume pad prink ink and laser-sensitive material.

In an aspect, a tube with a laser-sensitive coating may include a tube and a coating applied on a portion of the tube comprising a mixture of ink, such as pad print or screen print ink, and a laser-sensitive, color changing material. At least one of the top and bottom is flat. The tube may be at least one of plasma-, corona-, or flame-treated prior to receiving the coating. The coating may be at least one of air-dried, oven-dried, and UV cured. The tube may be molded or blown. The coating may be applied to at least one of a curved side, a top, and a bottom of the tube. The coating may be marked using a CO₂ or other low power laser to excite the laser-sensitive material. The tube may be designed for use in a life sciences field. The laser-sensitive, color-changing material may be at least one of a mica-based pigment, DERUSSOL A, FW 200, an aluminum-based pigment, an oxyanion of a multivalent metal, ammonium octamolybdate, molybdenum trioxide, and MAXITHEN. In certain aspects, the coating is applied to an insert, wherein the insert is placed at least one of on top of the tube, on the bottom of the tube, and around the tube.

In an aspect, a tube with a laser-sensitive coating may include an molded tube and a coating applied on a portion of the tube comprising a mixture of pad print ink and a laser-sensitive material. At least one of the top and bottom is flat. The tube is at least one of plasma-, corona-, or flame-treated prior to receiving the coating. The coating is at least one of air-dried, oven-dried and UV cured. The coating is applied to at least one of a curved side, a top, and a bottom of the tube.

In an aspect, a tube with a laser-sensitive coating may include an molded tube, a coating applied on a portion of the tube comprising a mixture of pad print ink and a laser-sensitive material, and at least one of a 1D- and 2D-barcode marked on the coating. At least one of the top and bottom is flat. The tube is at least one of plasma-, corona-, or flame-treated prior to receiving the coating. The coating is at least one of air-dried, oven-dried, and UV cured. The coating is applied to at least one of a curved side, a top, and a bottom of the tube. The coating is marked using a CO₂ laser.

In an aspect, a tube with a laser-sensitive coating on an insert may include an injection molded tube or a molded tube, and a coating applied on an insert comprising a mixture of pad print ink and a laser-sensitive material, wherein the insert is placed at least one of on top of the tube, on the bottom of the tube, and around the tube. At least one of a 1D- and 2D-barcode is marked on the coating. At least one of the top and bottom is flat. The tube is at least one of plasma-, corona-, or flame-treated prior to receiving the coating. The coating is at least one of air-dried, oven-dried, and UV cured. The coating is marked using a CO₂ laser.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 depicts a front-end view of a laser marking system.

FIG. 2 depicts an isometric view of a laser marking system.

FIG. 3 depicts a side view of a laser marking system.

FIG. 4 depicts labeled tubes in a rack.

FIG. 5 depicts an embodiment of a laser marking system.

FIG. 6 depicts an embodiment of a user interface.

FIG. 7 depicts a tray of tubes with laser-sensitive material being presented to a laser for marking.

FIG. 8 depicts a possible embodiment of a laser marking system in which a laser is mounted on top of an enclosed chamber. In the chamber is a translational stage on which adapters or trays holding tubes or other articles may be placed.

FIG. 9 depicts a conceptual block diagram of a possible embodiment of a laser marking system.

FIG. 10 depicts an embodiment of a user interface.

FIG. 11 depicts a laser ablation process.

FIG. 12 depicts a laser marking process.

FIG. 13 depicts a laser marking system.

FIGS. 14A and 14B depict radial isometric views of a laser-marked tube and FIG. 14C depicts a bottom isometric view of a laser-marked tube.

### DETAILED DESCRIPTION

In an aspect, a laser-marking system for surfaces of articles, such as plastic or glass tubes, polypropylene, polystyrene or polyethylene articles, vials, cryovials, cryogenic vials, microcentrifuge tubes, culture tubes, microtubes, strips of tubes, blood tubes, clinical test tubes, custom-made tubes that have yet to be designed, histo-cassettes, microplates, 96-well plates, cell culture plates, microcentrifuge tubes, microscope slides, PCR tubes, microscope slides, petri dishes, screw cap tubes, conical tubes, snap cap tubes, cluster tubes, paper, polyolefin, foil films, corrugate and folding cartons, custom labware, and the like, may take advantage of laser-sensitive materials that can be located on the surface of the article, wherein the material, when excited by a low-power CO₂ laser, is transformed.

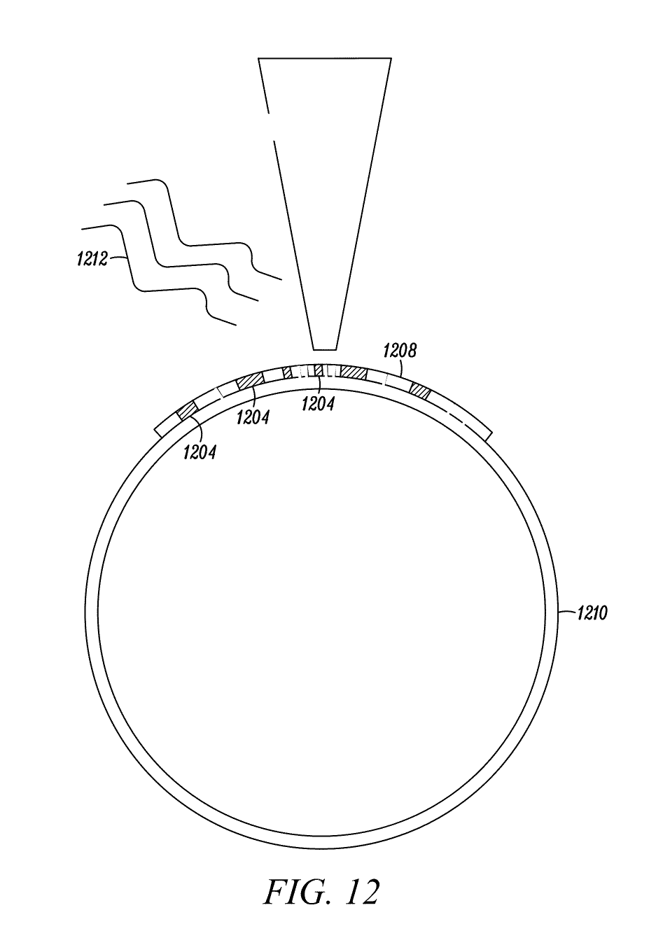

Referring to FIG. 12, one such transformation may result in a colorimetric change in the material 1208 such that when the laser 1202 excites the material 1208 in a pattern on the surface of an item 1210, the pattern may become apparent because of the colorimetric change, providing high-resolution and high-contrast marking 1204 or printing. During laser marking, a small amount of smoke 1212 may be emitted during the chemical change. Exciting the material in a pattern may be done either by moving the article relative to the laser or laser beam (e.g. articles are picked up by a picker and brought near the laser and that picker furthermore moves the article in the pattern of the identifier while the laser is stationary), or by moving the laser or laser beam relative to the article, or a combination thereof. In any event, software may be used to program the translation of either the article or the laser or the laser beam in order to generate a desired pattern, wherein the pattern is provided to the software by a user or other data source, such as a database, Microsoft Excel® spreadsheet, LIMS integration, and the like. The pattern can be anything, including graphics, logos, symbols, hazardous material warnings or codes, shapes, alphanumeric characters, letters, numbers, graduation marks, punctuation, drawings, images, barcodes (2D, 1D, linear, Code 39, 93, 128, data matrix), QR codes, OCR, serial numbers, date of marking, expiration date of contents, time, and the like. The disclosure herein describes a laser system able to print at the proper wavelength to effect a color change in tubes printed with an ink mixture including a laser-sensitive material and produce a substantially indelible marking; (b) a software user interface for users to indicate markings to be put on tubes and to control a laser to make the markings; and (c) a manufacturing process to consistently place—and have that placement resist solvents, extreme temperatures, long-term storage, etc.—a mixture of laser-sensitive material and print ink on a variety of tubes. Use of the laser marking system enables users to do their own tube marking using their own marking protocol/numbering system/data, as opposed to that of a manufacturer's, and allows users to mark on-site. Laser marked identifiers are less likely to jam in secondary equipment (e.g. life science equipment) that uses a tight fit, as compared to an adhesive label, which may be slightly wrinkled. Further, a laser marked identifier is less likely to peel off in hot (boiling water) or cold (liquid nitrogen temperatures for storage) temperatures, such as in use in life science applications, since the ink is waterproof, alcohol-proof, solvent resistant, and durable at low temperatures, such as −80° C., and in liquid nitrogen. The printing technique used may be pad printing, and while this technique will be used as exemplary throughout this specification, it is understood that other printing technique may be used to apply the ink and laser-sensitive material to the tubes, such as gravure printing, screen printing, flexography, ink-jet printing, and the like or non-printing techniques such as an ultrasonic weld of a thin film. Items may be marked at high speed, such as 2,500 tubes per hour. The number of items printed per run may be variable depending on media type and amount of information to be marked, such as 8-96 items per run.

In an embodiment, the laser-sensitive material may be a chemical or a chemical with a binder that undergoes a colorimetric change when excited by a laser. While not limiting this disclosure to any particular mechanism of action, the colorimetric change may occur because of a change in oxidation state. Examples of suitable compounds include (a) mica-based pigments such as LazerFlair® 800, 805, 810, 830 and IRIODIN 8000 Series from Merck KGaA (Darmstadt, Germany), (b) carbon compounds from Evonik Industries, such as DERUSSOL A and FW 200, (c) aluminum-based pigments such as LASERSAFE 040 or ULTRASTAR from Eckart Industries (d) oxyanions of multivalent metals such as ammonium octamolybdate (such as provided by provided by U.S. Pat. No. 7,485,403 to Datalase, Ltd. (Cheshire, GB)) or molybdenum trioxide (such as provided by United States Patent Application 2010/0018957 to Siltech, Ltd. (Nottingham, UK)), (e) other additives such as MAXITHEN from Gabriel-Chemie (Germany). The chemicals may be mixed with binders (e.g. PVC, EBECRYL 657, EBECRYL 1608, polyvinyl alcohol, Alcotex 395B, ethyl cellulose, hydroxypropylcellulose, Mowital B30H), solvents (e.g. water, methanol/methacrylate, ethanol, IRGACURE 651 or other photoinitiator), image forming materials (e.g. phenols, phenolic resins, carboxylic acids and a color-former, Crystal Violet Lactone), absorbing agents (e.g. clays, micas, titanium dioxide, carbonates, oxides, talcs, silicates, and aluminosilicates), and/or pigments (e.g. calcium carbonate, zinc oxide, titanium dioxide, and talc) before applying it to the article. An embodiment of one process for laser marking an article coated with a laser-sensitive material may include applying a Datalase® material to a material, such as polypropylene, polyethylene, paper, polyolefin, foils, films, corrugate, folding cartons, plastics, metals, or the like in a printing process, such as gravure, screen, lithography, or flexographic. The target area for imaging may be specified by a user on the material. The material is then sent to the user to be applied or used in for primary or secondary packages. Variable information is imaged onto the package using a CO2 laser at the time of production. Datalase® materials can be formulated into a broad range of coating vehicles, including water-based, solvent-based, and UV curable. Marking speed is application-dependent, but may be up to 2000 characters per second. The marking field may be up to 400 mm×250 mm. Examples of preferred laser systems include Videojet 3020, 3120, & 3320; Domino D120i & D320i; Markem-Imaje C150/350; Macsa id/IDTechnology iCON & K-1000 series; and REA Jet CL.

Other oxyanion-containing compounds include compounds where the cation is an alkali or alkaline earth metal and where the oxyanion is tungstate, paratungstate, metatungstate, di- and hepta-molybdates or analogous transition metal compound. Any laser-sensitive material that undergoes a laser-mediated colorimetric change may be useful in marking articles with a unique identifier.

Other possible compounds include oxides or salts of transition metal oxyanions, indium tin oxides (ITO), other transition metal oxides, and the like.

In an embodiment, the laser-sensitive material may be coated onto the surface of a tube such that it can be exposed to a laser. One method of applying a coating may include pad printing the tube with ink that contains the laser-sensitive material. In an embodiment, white pad print ink is mixed with laser-sensitive material. The mixture may be in any proportion such as 1:1, 2:1, 1:2, or any other useful proportion. One exemplary process for preparing the mixture includes mixing 50g standard white pad print paste (PLT9 white ink from Engineered Printing Solutions, EPS) with 5 g of standard hardener (PLH from EPS) and stirring. The solution may be thinned with a standard thinner (PLTA), such as 10 g of thinner in this example. Then, 5 g at a time, a total of 45 g of a laser-sensitive dopant/material is mixed into the mixture. The mixture is blended or stirred. Particle size may be measured with a grindometer to determine if the particles are fine enough. In one embodiment, the particles are below a 10 um threshold. If the measurement indicates that the particles are above the threshold, then they are further ground, such as by using a planetary ball mill to grind down the ink so that particles are less than 10 um. The ink is then loaded into a pad print ink cup.

Shortly after tubes are released from molding, they may be plasma-, corona- or flame-treated for a period of time, such as a few seconds, 3 seconds, or the like. Exemplary corona-, plasma- or flame-treatment devices include Enercon Industries Dyna-Mite-HD. Such treatment may raise the surface energy of the tube and improve adhesion, such as by breaking chemical bonds on the surface of the tube and allow for later-applied liquids to adhere to the tube. Then, the pad print ink mixed with laser-sensitive material may be applied to the tube using a standard rotary pad printer (e.g. KP-05 pad print machine) to form a coat. The pad printer may be adapted with fixtures to grip specific items such as tubes. For example, the fixture may include a pair of walls designed to grip a tube along its sides or a hole designed for a tube to stand in. Pad printing may take place within a period of time, such as within 2 hours. By way of example, for a standard 2 mL cryovial tube, the pad print image would be 1″×0.4″, while for a glass 2 mL HPLC vial the image would be 0.8″×0.3″. The coating may be allowed to air dry, such as for 1-5 days, or may be cured using UV light. Another method may involve delaying application of the coating so that it does not happen immediately after molding the tubes. For example, after molding, the tubes may be packaged and sent to another facility where they are then corona- or flame-treated, coated with the pad print ink and laser-sensitive material combination, and then exposed to laser to mark the tube.

In another embodiment, the laser-sensitive material may be coated onto the surface of an article using a film. One side of a thin transparent plastic film may be coated with the laser-sensitive material. The film may be die cut to a suitable shape and size to be ultrasonically welded to the tube with the coated side on the inside to provide superior solvency resistance. Alternatively, the film may be doped with the laser-sensitive material. In any event, in order to mark the tubes with identifiers, end users may use a laser. In one embodiment, users may receive tubes with the thin film already welded to the tube in preparation for laser marking In other embodiments, users may receive tubes and film separately, such that the user uses an integrated laser and welding system to weld the film to raw tubes and then mark the identifier thereon. In embodiments, ultrasonic welding and laser marking may be accomplished with separate devices, however, a combination welding and marking device may also be used. In such a device, a sonotrode may be positioned to emit acoustic vibrations sufficient to weld the film to the tube. Once the film is welded, either the tube is moved to the laser or the laser is moved into position relative to the tube to mark it with an identifier.

Another option is to have a thin film plastic either be coated or include the laser-sensitive material. The thin film plastic may be an undersized rectangular ring that the tube may be placed into. Bonding between the plastic and the ring may occur spontaneously or may occur with the application of heat.

Another option is to mix the laser-sensitive material into a solvent-base and ink jet it onto the tubes.

Another option would be to use direct thermal transfer via ribbons of a full patch of thermally-applicable material including the laser-sensitive material.

In an embodiment, chemical or evaporative deposition of the laser-sensitive material may also be an option to get the material onto tubes.

As an alternative to pad printing the tubes with laser-sensitive material, the laser-sensitive material may be mixed into a master batch of moldable plastic at a pre-set percentage and compounded. The mixture may then be molded into tubes as usual such that the laser-sensitive material is dispersed throughout the molded tube.

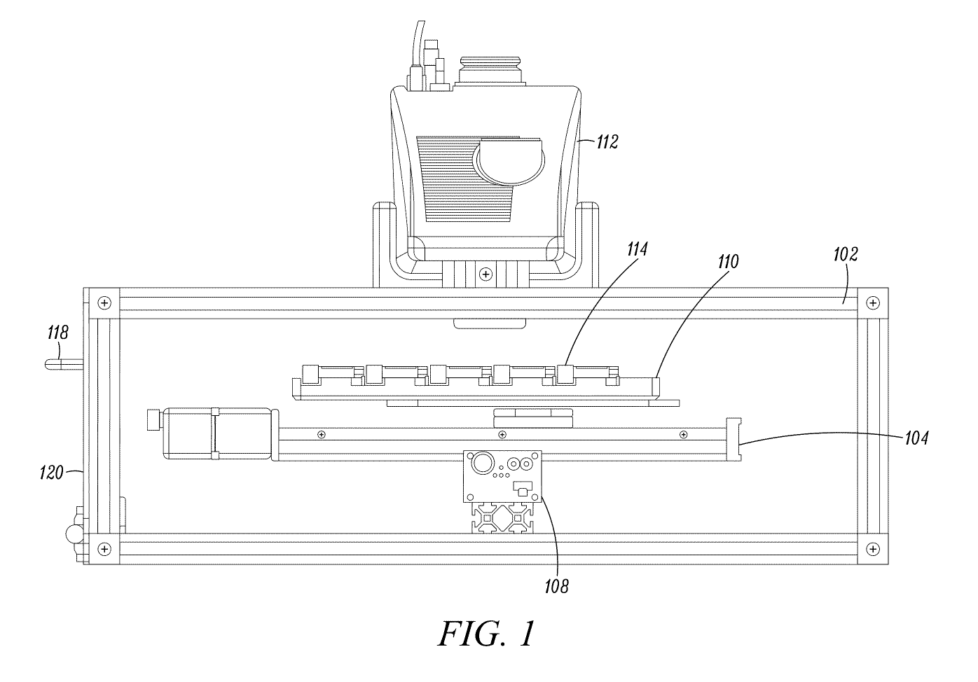

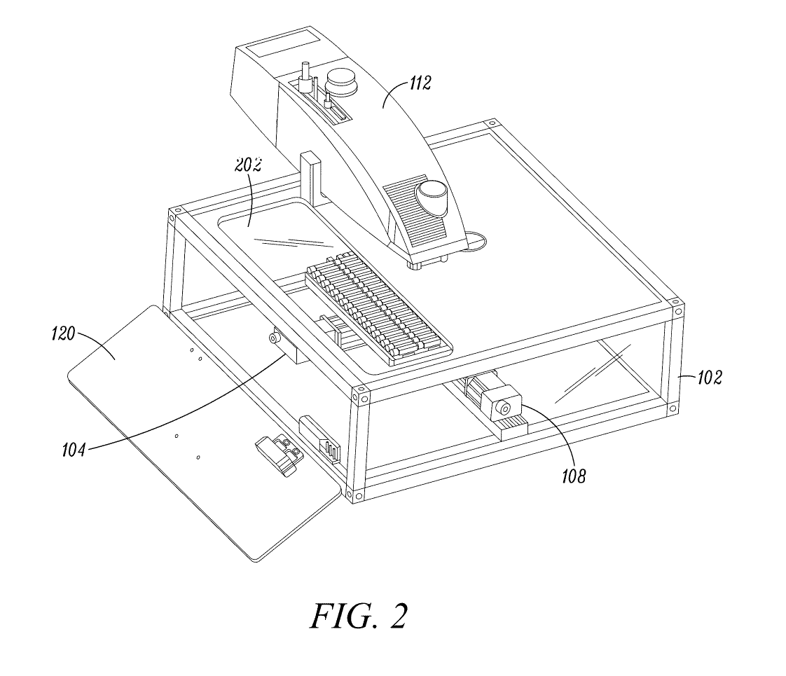

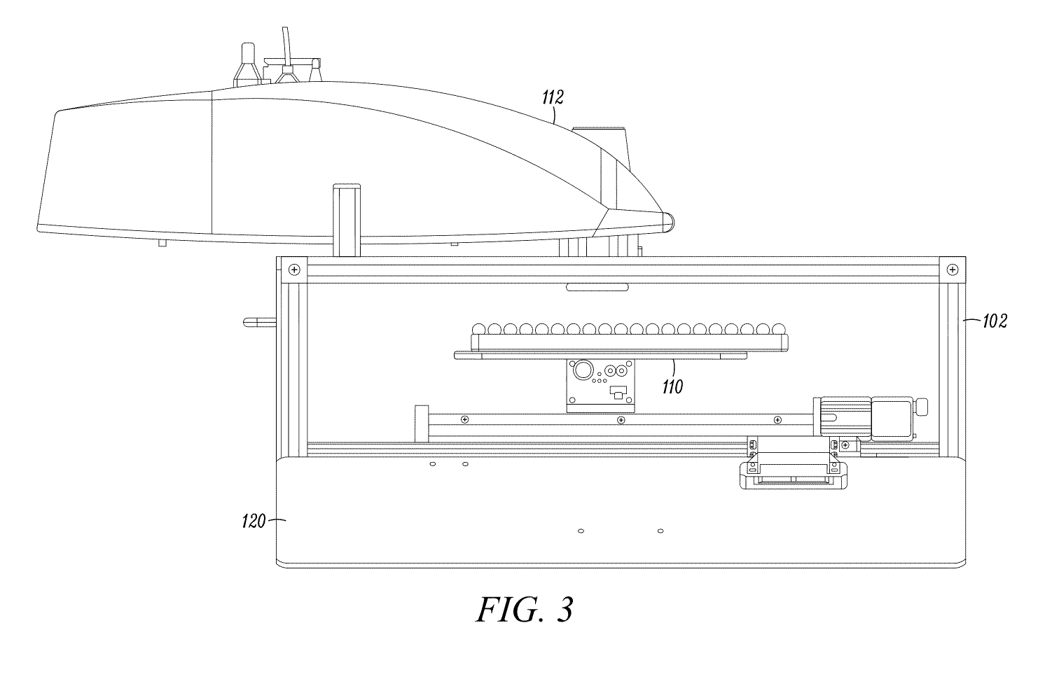

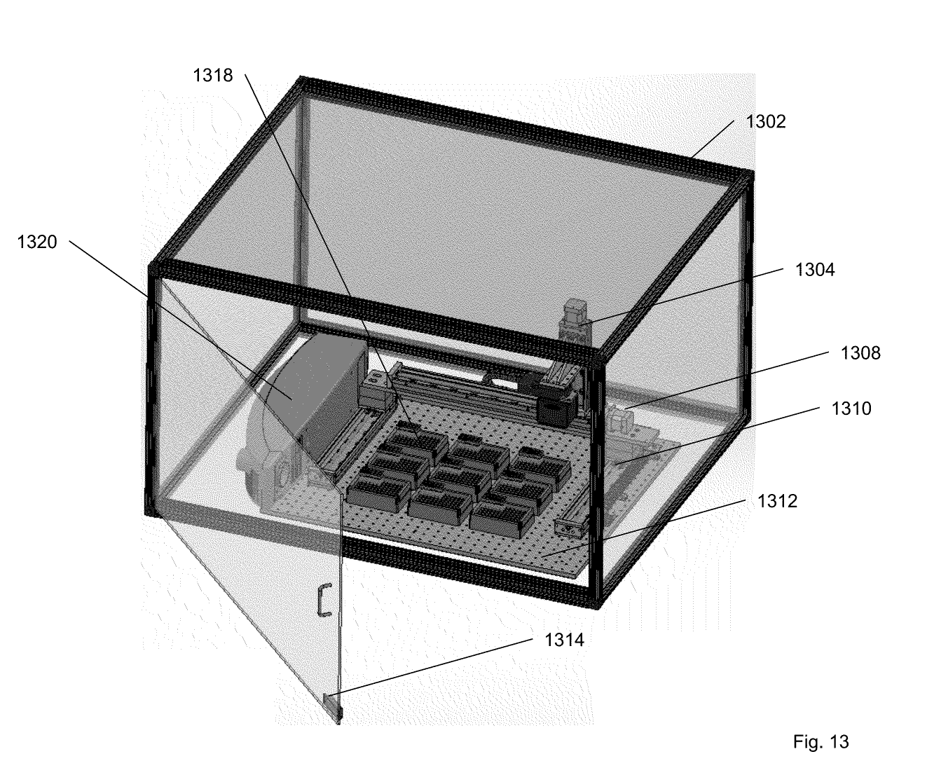

Once the laser-sensitive material has been applied to the tube or incorporated into the material of the tube, the tubes may be marked using a laser. In one embodiment, the tubes are presented to a laser marking system. FIG. 1 depicts a front-end view through side 102 of an embodiment of the laser marking system. The stage 110 of the laser marking system runs along track 104 and track 108 that are disposed perpendicularly to one another to provide x-y translational movement of the stage 110 for presentation of tubes 114 to the laser 112. The side door 120 to the area within a laser marking system holding the stage can be opened with the handle 118. In embodiments, a third track may be added such as to provide translational movement along a z-axis. FIG. 2 depicts an isometric view of the laser marking system from FIG. 1 with the door 120 open. A window 200 may be present to provide a view of the stage. In embodiments, items or the stage are moved within the chamber to the window for presentation to the laser along tracks 104 and 108. Items or stages may move in the x and y axis while the laser fires in order to be marked. This is a laser marking system with “galvos”. The galvos are two quick-moving gold-plated mirrors. The laser beam is sent and re-directed by 112 to produce a full image on one item or tube. FIG. 3 depicts a side view of the laser marking system through the open door 120. Referring to FIG. 13, the laser 1320 and the items 1318 are both disposed inside the chamber 1302. In this view, the chamber 1302 is shown with the door 1318 ajar. The laser 1320 is lying on its side and a gripper system 1304 grabs items from the stage 1312 for individual presentation to the laser 1320. The gripper moves along 1308 and track 1308 moves along track 1310 so that the gripper 1304 can reach every item presented on the stage 1312. In certain embodiments, the laser marking system may include a stationary and pulsed laser. This laser would not have any galvos but would simply be a beam of light that can be pulsed. In this scenario, not only would the tracks move a particular tube in front of the laser, but would also move “intra-tube” and “intra-image” to trace out the image.

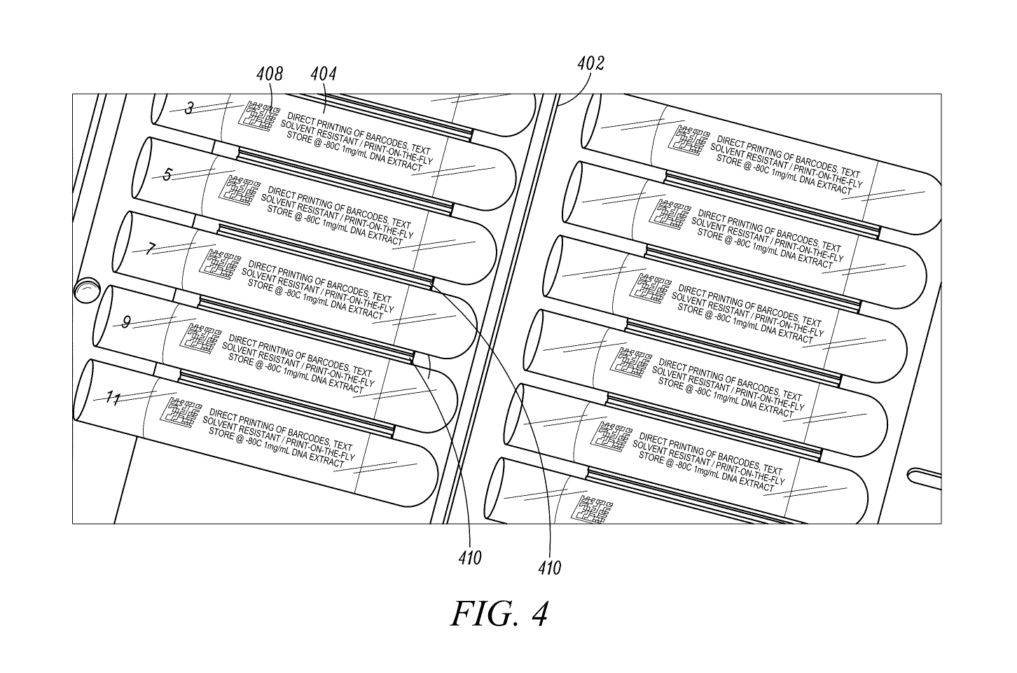

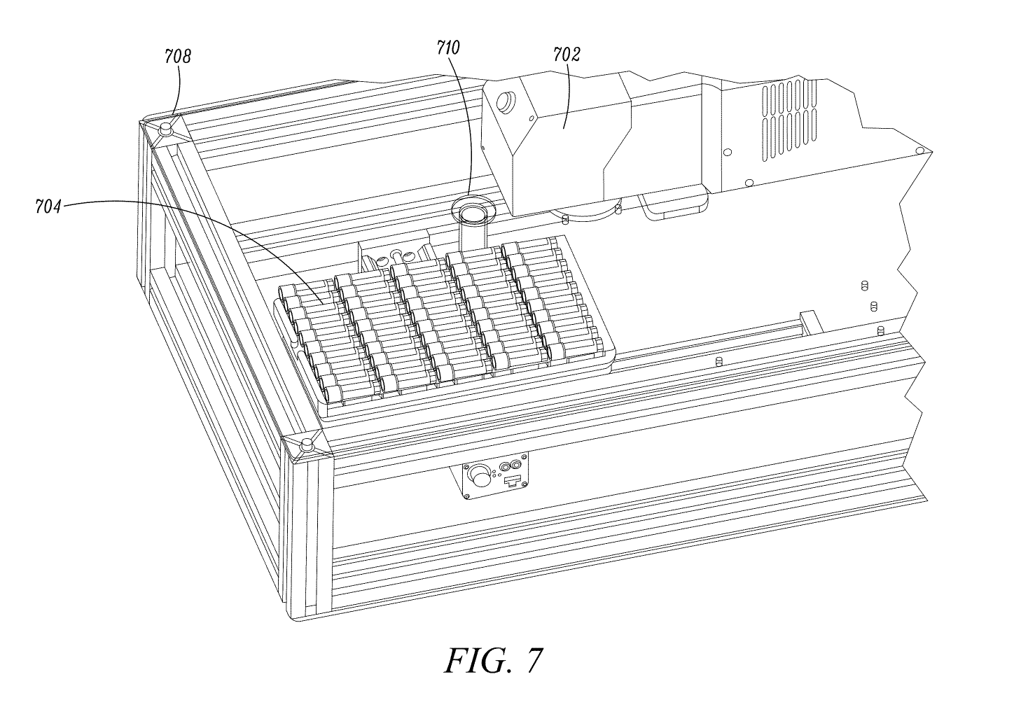

The laser marking system may include a software user interface that at least one of (1) accesses data to be marked onto the tubes; (2) optionally modifies or validates the data; (3) and transmits the data to the laser controller or firmware of the laser. The arrangement may include presenting tubes singly to the laser, mounting tubes in a receptacle to be presented to the laser and translated in various dimensions with respect to the laser, or mounting the tubes in such a manner that allows the laser to be moved to the tubes. Tubes may be presented horizontally, vertically, or rotating radially while the mark is being made. For example, tubes may be mounted in V-shaped slots or pairs of walls 410, such as in a specially made vacuum-formed tray, that are themselves mounted on an x-y stage. The tubes may lay horizontally with the patch of pad print ink mixed with laser-sensitive material facing up, as shown in FIG. 4 or FIG. 7. In FIG. 4, the patch 404 of print ink is shown as well as markings 408 made by the laser changing the color of the ink in the patch at the specified positions. In another example, the tubes would be stored upright, and a gripper arm would pick each tube and bring to the laser for marking As the software instructs the laser to mark a tube, the tube is marked by tracing the pattern of the desired marking with the laser or laser beam. Then, the stage moves the next tube into position or the gripper arm exchanges the marked tube for an unmarked tube. In some embodiments, the stage may be an x-y-z stage and the controller may be programmed to move along any combination of x, y, and z axes. In order to accurately present the patch of pad print ink to the laser, the tubes may be mounted on differently-sized racks selected to place the patch at the appropriate location for impingement by the laser in the x-, y- and z-axes. For example, the rack 400 shown in FIG. 4 has a stop 402 on one end in order to consistently position the tubes all at the same x-axis position. Also the thickness of the rack and its removed material may determine the z-axis position of all the tubes.

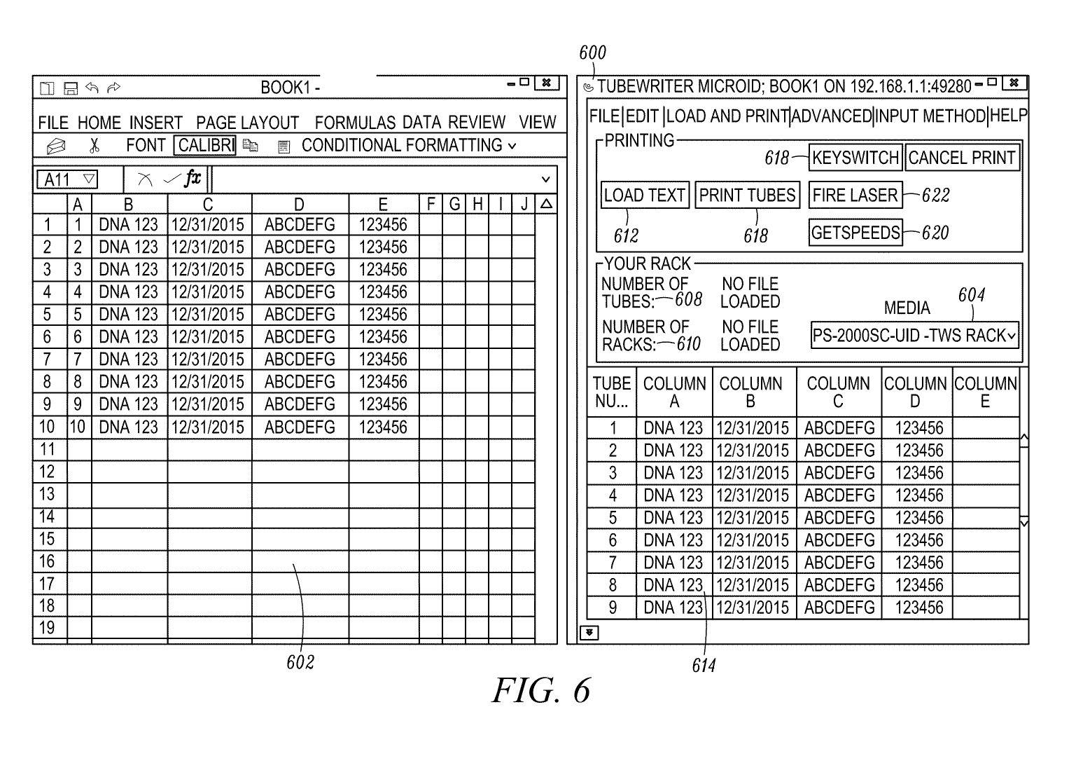

In embodiments, a user interface may be used to program the action of the laser marking system. For example, users may select the tube or article type via a ‘Media’ drop-down menu, number of tubes/articles to be printed, input text or other information to be printed, input a data source for the text/information via the ‘Load Spreadsheet’ option, confirm the kind of ink/laser-sensitive material on the tube, and so on. In an alternative embodiment, the data source may be via a comma delimited file, another sample that has just been previously scanned by a handheld barcode reader, a LIMS integration, a database, or even from a server to a larger client automated life science instrument. A spreadsheet may be used as the source data and a field may describe the text of the first mark and the text of the last mark. When printing is commenced, such as by hitting a ‘Print’ button, printing begins with the first mark in the spreadsheet onto the first tube for presentation. When the printing of that mark is complete, the stage is moved or the laser is moved such that the next tube is presented to the laser and the next mark is printed. This process continues until the final mark text is reached in the spreadsheet after which printing is terminated and the laser marking system may pause operation or shut down, or may wait for the user or client in a client-server robot system to load another fresh set of tubes. Referring now to FIG. 6, an embodiment of a user interface 600 for operation of the laser marking system is shown. The user interface 600 may call application programming interfaces (APIs) on the back-end of the laser software to trigger the laser to generate the desired text or other information, to provide or modify the desired text or other information for each tube, instruct the stage or laser to move to the next tube, and the like. For example, users may select the tube or article type via the ‘Media’ drop-down menu 604, number of tubes/articles 608 to be printed, number of racks 610, input text or other information to be printed, input a data source for the text/information via the ‘Load Text’ option 612, confirm the kind of ink/laser-sensitive material on the tube, and so on. In an alternative embodiment, the data source may be via a comma delimited file, a LIMS integration, or a database. In this example, a spreadsheet 602 is used as the source data and a field 614 shows the loaded text from the spreadsheet 602. When printing is commenced, such as by hitting a ‘Print Tubes’ button 618, printing begins with the first label in the spreadsheet onto the first tube for presentation. When the printing of that label is complete, the stage is moved or the laser is moved such that the next tube is presented to the laser and the next label is printed. This process may continue until the final label text is reached in the data loaded from the spreadsheet after which printing is terminated and the laser marking system may pause operation or shut down. KeySwitch 618 may disable the software lock that is on the laser. Get Speed 620 is a diagnostic tool to read the speeds on the mechanical stages. Fire Laser 622 activates the laser.

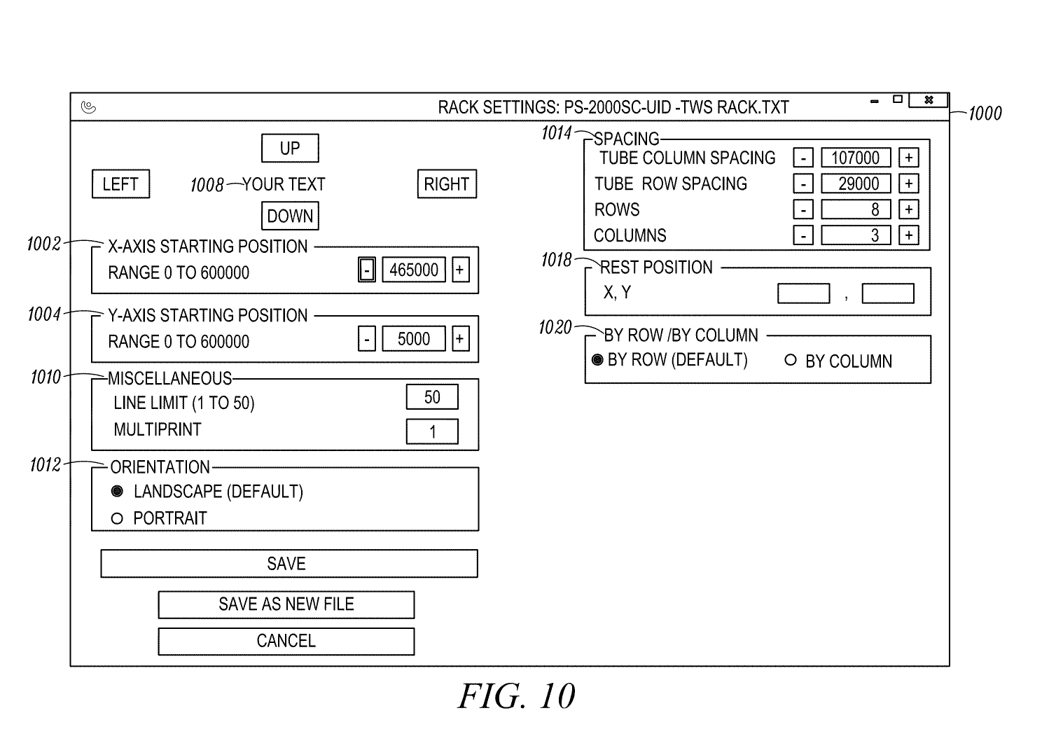

In embodiments, the laser marking system may automatically detect a rack, tube or item on the stage, such as by using imaging capabilities of the laser marking system or an associated optical electronic encoder. In this case, automatic detection of a particular rack or item may cause (a) the Media drop down menu 604 to automatically change to the appropriate selection (b) a tube slot to be reported as not having a tube therein; (c) a tube oriented incorrectly either in x or y-axis placement or rotationally with the white patch at the wrong position; or (d) poorly, according to grading or scanning, marked barcode or human-readable text. Each Media selection in the menu 604 may be associated with certain dimensions and programming for the movement of the laser or stage such that the stage or laser can be moved precisely to accurately mark items presented to the laser. For example, a rack that is sized and adapted to hold particular test tubes may have a registration mark or code that is detected when the rack is placed in the laser marking system. The laser marking system may be pre-programmed with the dimensions and a motion plan for the rack to accurately position itself at each of the patches of laser-sensitive material for each tube in the rack. Of course, based on the number of labels required to be marked by the laser, the programmed motion may terminate early if fewer than all of the tubes in the rack are to be marked. In other embodiments, the dimensions for the rack/tray, items, or items on the rack/tray may be input by a user, such as into a user interface 1000 as depicted in FIG. 10, which may be used to provide rack settings. The x-axis starting position 1002 field may be used to position the item or rack in a range of x-axis values. The y-axis starting position 1004 field may be used to position the item or rack in a range of y-axis values. Alternatively, the position may be modified using left, right, up, and down buttons of a manual placement tool 1008. Miscellaneous items 1010 may also be input, such as line limit, character limit, multiprint options, and the like. The item or rack orientation 1012 may be selected from portrait or landscape. Spacing 1014 may be set, such as a tube column spacing integer, a tube row spacing integer, number of rows, number of columns, and the like. A rest position 1018 may be indicated, such as an x-y position or an x-y-z position. Preferences 1020 for movement by row or column may also be indicated.

In embodiments, the laser marking system may be integrated into a larger robotics system as a module. For example, the laser marking system may be integrated into a laboratory platform that may include robotic arms such as liquid handling arms, robotic manipulator arm, pick and place arms, and multichannel arms. For example, as tubes are marked in the laser marking system, a robotic arm of the laboratory platform may remove the marked tubes and manipulate them using another facility of the laboratory platform, such as to fill the newly marked tubes with contents.

The laser may be a CO₂ laser, such as a 10.6 um wavelength CO₂ laser. One exemplary laser is a VideoJet 3120 CO₂ laser. Other lasers may also be useful, such as Nd:YAG, Nd:YLF, Nd:YVO₄, and others. In any event, the laser may have a wide area, sufficient to enable exposing tubes or trays of tubes to the laser. In a possible embodiment, the initial intensity setting may be at approximately 15% and may use a 100 mm lens. In other embodiments, the laser may be set at 3 W. The laser may be a high-speed, laboratory safe laser.

In one embodiment, the laser marking system may include a motion control system such as a translating table, which can move rapidly and accurately in directions X, Y and Z. In addition, the translating table may accurately locate the tubes or tray of tubes to be laser marked relative to the laser, such as by using a series of positive stops and tapered mounts to mount the tubes or tray of tubes, an imaging system, or by use of pre-selected tube holders whose parameters are known by the controller or software. A camera included with the laser marking system may image the translating table and tubes mounted on the translating table, and use the image to position the tubes or tray of tubes in line with the laser. For example, the camera may image a marker on the tray or rack that may provide location information for where exactly the patch of pad print ink is. In another embodiment, the tubes or tray of tubes are fixed and the laser and/or camera are mounted on a translating table so that the laser travels or laser beam is deflected to each tube and can be positioned at varying distances away from the surface of the article to be laser marked. An initial alignment may be done based on known dimensions of the tubes or tube of trays when mounted in the laser marking system, and a finer positioning may be done and facilitated by imaging. The motion control system may also be programmed to adjust motion of the laser, laser beam or tubes in accordance with user input or pre-made but adjustable software files containing settings and parameters.

Once the laser or tube, or tray of tubes, is in position, a controller executes a process to move the laser or deflect the laser beam relative to the tube, or the tube relative to the laser, in a pattern based on data provided to the laser controller. The energy provided by the laser causes a transformation in the laser-sensitive material of the tube or a coat/film thereof. In some embodiments, the transformation is a color change, such as from white to black, transparent to black, transparent to white, and the like.

In one example, a laser marking system may include a CO₂ laser, two linear stages, an adapter to hold tubes in the vertical or horizontal position, and software, in order to mark on doped, coated or filmed test tubes.

In embodiments, using a camera of the laser marking system, quality control may be performed immediately following marking. The camera may take an image of the newly marked tube, analyze the image for defects, and make a notation in software or otherwise mark the tube for destruction. If the tube is deemed to be defective, the system may automatically mark a new tube with the marking from the prior defective tube.

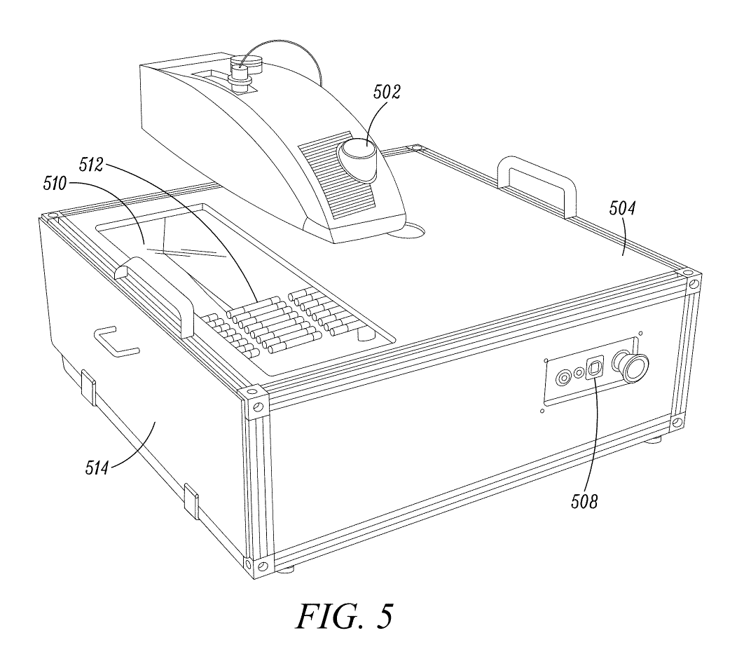

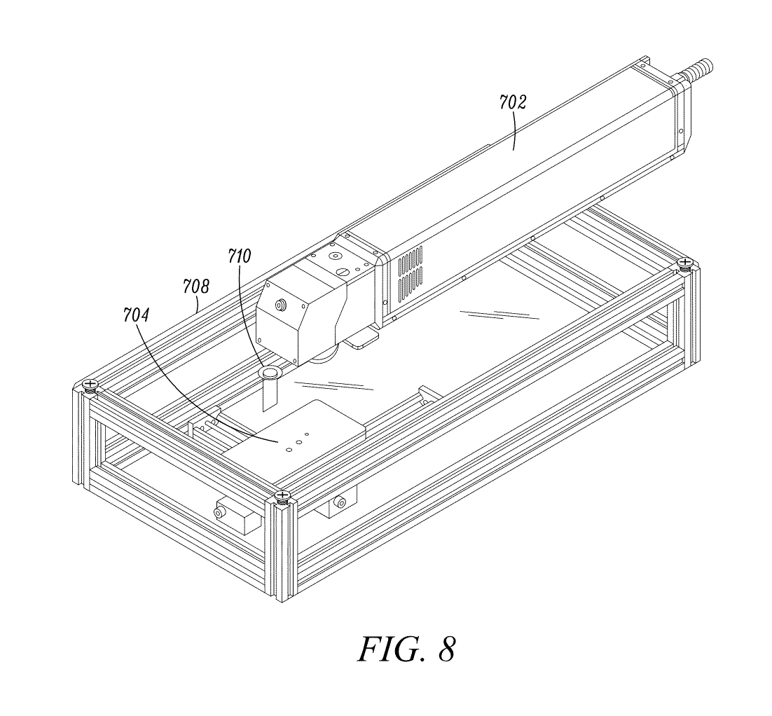

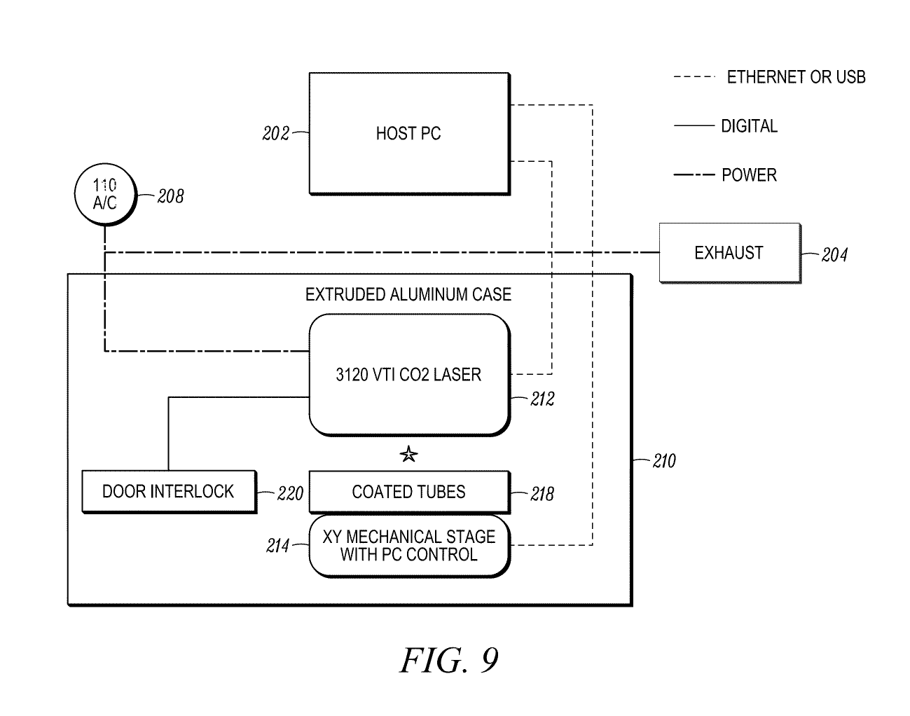

FIG. 5, FIG. 7, FIG. 8 and FIG. 9 depict conceptual models of possible exemplary embodiments of laser marking systems. In FIG. 9, the laser marking system is at least partially housed in a case 210 and includes a laser 212, mechanical stage with PC control 214, power source 208 (e.g. 110 A/C or 120 A/C), door interlock 220, and exhaust 204, the laser and stage under control of the Host PC/PLC 202. Coated tubes 218 are introduced to the laser marking system at the stage 214. FIG. 7 and FIG. 8 depict a possible laser system in which a laser 702 is mounted on top of an enclosed chamber 708. In the chamber 708 is a translational stage 704 on which adapters, racks, or trays holding tubes or other articles may be placed. Also present is an air filtration tube 710. FIG. 5 depicts an exemplary benchtop laser marking system with laser 502 mounted above a chamber 504. Inside the chamber 504, as viewed through a window 510 of the chamber, can be seen tubes 512 that are mounted on a stage. A door 514 allows access to the interior of the chamber. A user interface 508 for controlling the system is included, but the system may also be controlled remotely and/or wirelessly.

In an exemplary process, the laser-sensitive material may be applied to the tube at the facility where the tubes are manufactured or in a secondary facility, and the tubes may be marked thereafter at a customer site or at a separate location at the manufacturer's or secondary facility, for example a printed run specified by a customer of that manufacturer. After releasing the tubes from molding, they may be corona-, plasma- or flame-treated and a 50/50 ink/laser-sensitive material mixture may be applied using a pad or screen printer, either planar or rotary, which may then be allowed to air dry, oven dry or cure, possibly with UV. At this point, the tubes may be delivered to a customer or other facility for marking or the tubes may be marked in the same facility where the laser-sensitive material was applied. The tubes may then be presented to a laser marking system that includes application software to retrieve the identifying data to be marked on the tubes. This data is sent to the firmware of a VideoJet 3120 CO₂ laser. Tubes may be arranged underneath said laser mounted in V-shaped slots that are themselves mounted on an x-y stage, or x-y-z stage. As the software instructs the laser to mark a tube, the stage moves the next tube into position, or keeps the tubes stationary and deflects the laser beam, or keeps both the laser and laser beam stationary and pulses the laser beam and moves the tube. A different set of markings may be applied to that next tube.

In another exemplary process, the laser-sensitive material and mark may be added in a secondary process at a secondary facility. After the tube is released from molding, the tube may be packaged by the manufacturer. The tubes may then be drop shipped to the printing facility. The tubes may then be plasma-, corona- or flame-treated at the printing facility. A pad print or welded film may be applied, and immediately thereafter at the printing facility, the tubes may be laser marked.

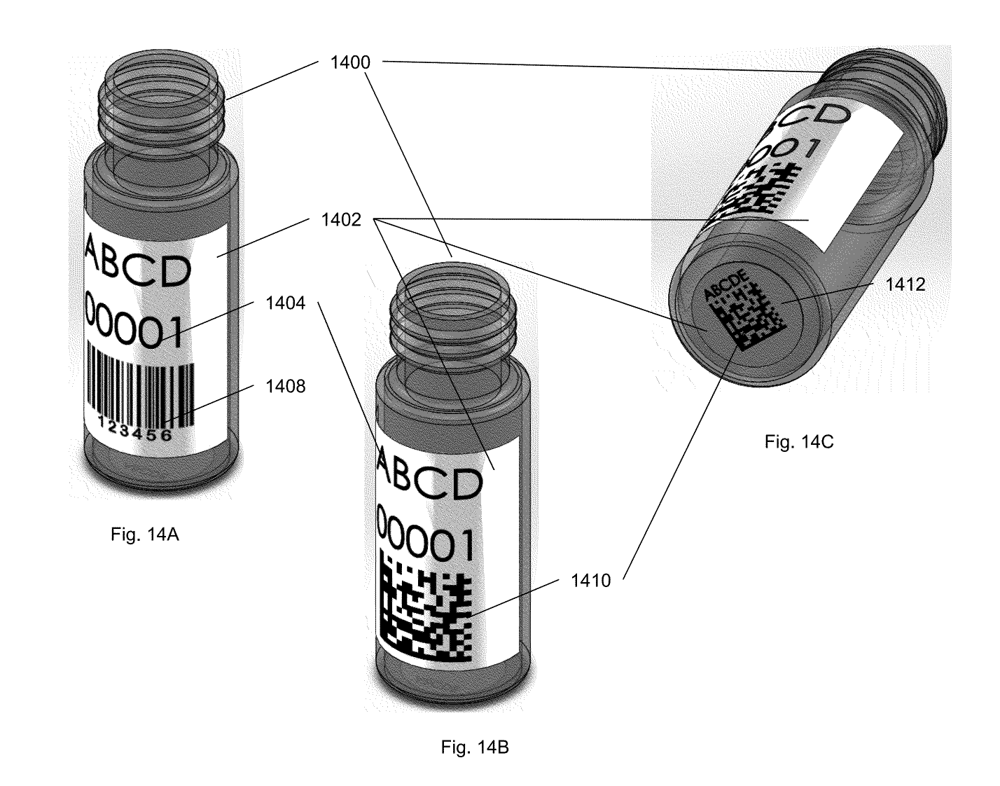

In an aspect, a glass or plastic test tube may be coated on one or more curved sides with a pad or screen printed ink containing a laser-sensitive material. In embodiments, a portion of the circumference of the tube may be printed with the ink and laser-sensitive material. In another aspect, a glass or plastic tube may be coated on a flat bottom, top, or cap with a pad printed ink containing a laser-sensitive material. In another aspect, a tube comprising a flat bottom and curved body, may be coated on at least one of the flat bottom or curved body with a laser-sensitive material to be marked by a CO₂ laser, such as with a 2D or 1D barcode. Referring now to FIG. 14A, a tube 1400 is shown with a patch 1402 of ink mixed with laser-sensitive material that has been marked with text 1404 and a 1D barcode 1408. In FIG. 14B, the laser marking of the tube includes a 2D code 1410. In FIG. 14C, it is the bottom 1412 of the tube that has been marked with a 2D code 1410.

In another aspect, a tube comprising a flat bottom and curved body may be molded with materials including a laser-sensitive material, wherein the tube can be marked by a CO₂ laser, such as with a 2D or 1D barcode.

In another aspect, a separate insert may be marked with the laser sensitive material mixed with ink. The insert may be laser marked with the unique marking and then assembled with a tube to form a tube and insert assembly with a unique identifier. The insert may be placed on the bottom of the tube, on the top of the tube, or it may wrap around the tube. Once marked, in order to keep the tubes in place during shipping, and in order to capture any fumes from lasering, the tray may optionally be shrink-wrapped in a polyolefin bag.

### ADDITIONAL STATEMENTS OF THE DISCLOSURE

In some implementations, systems for uniquely identifying an item with at least one curved surface may be described in the following clauses or otherwise described herein and as illustrated in FIGS. 1, 2, 3, 5, 7, 8, 9, and 13.

Clause Set A

Clause 1. A system for uniquely identifying an item with at least one curved surface, comprising: a laser mounted in translational relationship to a stage; a processor that receives information about placement of the item on the stage and translates the laser, laser beam or stage relative to the others in order to position the laser for marking the item; and a laser controller to move the laser, the laser beam, or the stage in accordance with data from a data source in order to effect a color change of a pad-printed, laser-sensitive material on the curved surface of the item.

Clause 2. The system of clause 1, wherein the information is received from a camera positioned along the same axis as the laser.

Clause 3. The system of clause 2, wherein the camera is positioned to capture an image of the item placed on the stage.

Clause 4. The system of clause 1, wherein the laser-sensitive material is mixed with an ink.

Clause 5. The system of clause 1, wherein the item includes an ultrasonic welded film comprising ink mixed with a laser-sensitive material.

Clause 6. The system of clause 1, wherein the item is a tube.

Clause 7. The system of clause 2, wherein the camera images a marker on the item that provides location information for where exactly the patch of pad print ink is on the item.

Clause 8. The system of clause 1, further comprising a gripper system for grabbing items to be held vertically and bringing them to the laser one by one.

Clause 9. The system of clause 8, wherein the gripper system rotates the items while lasering.

In some implementations, methods for identifying tubes may be described in the following clauses or otherwise described herein and as illustrated in FIGS. 6, 10, and 12.

Clause Set B

Clause 1. A method for identifying tubes, comprising: pad printing a tube with a mixture of ink and a laser sensitive material; programming a laser with an identifier for each tube; and exposing the laser-sensitive material to the laser to transform the laser-sensitive material from one color to another, wherein the transformation of the material reveals the identifier.

Clause 2. The method of clause 1, wherein the mixture is 50/50 pad print ink and laser-sensitive material.

Clause 3. The method of clause 1, wherein the laser is a CO2 laser.

Clause 4. A method for identifying tubes, comprising: pad printing a plurality of tubes with a mixture of ink and a laser sensitive material; mounting a laser in translational relationship to a stage; and translating at least one of the laser, a laser beam, and the stage relative to the others of the laser, the laser beam and the stage and in accordance with an identifier for each tube of the plurality of tubes in order to transform the laser-sensitive material on each tube from one color to another, wherein the transformation of the laser-sensitive material reveals the identifier.

Clause 5. The method of claim 4, wherein the plurality of tubes is placed into at least one rack on the stage, wherein the at least one rack normalizes a height of each tube of the plurality of tubes relative to a standard so that the laser-sensitive material on each tube is presented at a same distance from the laser regardless of a geometry of the tube.

Clause 6. The method of claim 5, wherein each tube of the plurality of tubes lays at least one of horizontally or vertically in the at least one rack.

Clause 7. A method for identifying tubes, comprising: screen printing a tube with a mixture of ink and a laser sensitive material; programming a laser with an identifier for each tube; and exposing the laser-sensitive material to the laser to transform the laser-sensitive material from one color to another, wherein the transformation of the material reveals the identifier.

In some implementations, processes for preparing an item may be described in the following clauses or otherwise described herein and as illustrated in FIGS. 6, 10, and 12.

Clause Set C

Clause 1. A process for preparing an item, comprising: at least one of corona-, plasma- or flame-treating a tube; pad printing a mixture of ink and laser-sensitive material onto the tube using a pad printer to form a coating; and performing an action comprising at least one of allowing the coating to air dry, oven drying, and UV curing the coating.

Clause 2. The process of clause 1, further comprising, presenting the coated item to a laser marking system; and instructing a laser to excite the laser-sensitive material on the tube.

Clause 3. The process of clause 1, wherein the mixture is 50/50 pad print ink and laser-sensitive material.

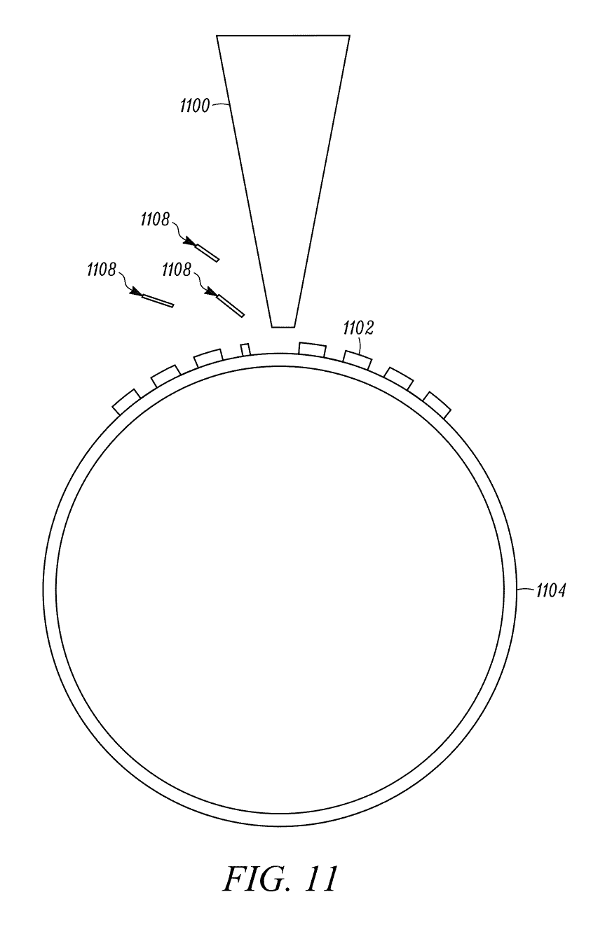

In some implementations, tubes with laser-sensitive coatings may be described in the following clauses or otherwise described herein and as illustrated in FIGS. 4, 11, 12 and 14A-14C.

Clause Set D

Clause 1. A tube with a laser-sensitive coating, comprising: a tube; and a coating applied on a portion of the tube comprising a mixture of ink and a laser-sensitive, color-changing material.

Clause 2. The tube of clause 1, wherein at least one of a top and a bottom of the tube is flat.

Clause 3. The tube of clause 1, wherein the tube is at least one of plasma-, corona-, or flame-treated prior to receiving the coating.

Clause 4. The tube of clause 1, wherein the coating is at least one of air-dried, oven-dried, and UV cured onto the tube.

Clause 5. The tube of clause 1, wherein the coating is applied to at least one of a curved side, a top, and a bottom of the tube.

Clause 6. The tube of clause 1, wherein the coating is marked using a CO2 laser to excite the laser-sensitive, color-changing material.

Clause 7. The tube of clause 1, wherein the tube is molded or blown.

Clause 8. The tube of clause 1, wherein the ink is pad print ink or screen print ink.

Clause 9. A tube with a laser-sensitive coating on an insert, comprising: a tube; and a coating applied on an insert comprising a mixture of pad print ink and a laser-sensitive, color-changing material, wherein the insert is placed on at least one of a top of the tube, a bottom of the tube and around the tube.

Clause 10. The tube of clause 9, wherein at least one of the top and the bottom of the tube is flat.

Clause 11. The tube of clause 9, wherein the tube is at least one of plasma-, corona-, or flame-treated prior to receiving the coating.

Clause 12. The tube of clause 9, wherein the coating is at least one of air-dried, oven-dried, and UV cured.

Clause 13. The tube of clause 9, wherein the coating is marked using a CO2 laser to excite the laser-sensitive material.

Clause 14. The tube of clause 9, wherein the tube is designed for use in a life sciences field.

Clause 15. The tube of clause 1, wherein the laser-sensitive, color-changing material is at least one of a mica-based pigment, DERUSSOL A, FW 200, an aluminum-based pigment, an oxyanion of a multivalent metal, ammonium octamolybdate, molybdenum trioxide, and MAXITHEN.

Clause 16. The tube of clause 9, wherein the tube is molded or blown.

Clause 17. The tube of clause 9, wherein the laser-sensitive, color-changing material is at least one of a mica-based pigment, DERUSSOL A, FW 200, an aluminum-based pigment, an oxyanion of a multivalent metal, ammonium octamolybdate, molybdenum trioxide, and MAXITHEN.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, all the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, all the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

What is claimed is:

1. A tube with a laser-sensitive coating, comprising:
a tube; and
a coating applied on a portion of the tube comprising a mixture of ink and a laser-sensitive, color-changing material.

2. The tube of claim 1, wherein at least one of a top and a bottom of the tube is flat.

3. The tube of claim 1, wherein the tube is at least one of plasma-, corona-, or flame-treated prior to receiving the coating.

4. The tube of claim 1, wherein the coating is at least one of air-dried, oven-dried, and UV cured onto the tube.

5. The tube of claim 1, wherein the coating is applied to at least one of a curved side, a top, and a bottom of the tube.

6. The tube of claim 1, wherein the coating is marked using a CO₂ laser to excite the laser-sensitive, color-changing material.

7. The tube of claim 1, wherein the tube is molded or blown.

8. The tube of claim 1, wherein the ink is pad print ink or screen print ink.

9. A tube with a laser-sensitive coating on an insert, comprising:
a tube; and
a coating applied on an insert comprising a mixture of pad print ink and a laser-sensitive, color-changing material,
wherein the insert is placed on at least one of a top of the tube, a bottom of the tube and around the tube.

10. The tube of claim 9, wherein at least one of the top and the bottom of the tube is flat.

11. The tube of claim 9, wherein the tube is at least one of plasma-, corona-, or flame-treated prior to receiving the coating.

12. The tube of claim 9, wherein the coating is at least one of air-dried, oven-dried, and UV cured.

13. The tube of claim 9, wherein the coating is marked using a CO₂ laser to excite the laser-sensitive material.

14. The tube of claim 9, wherein the tube is designed for use in a life sciences field.

15. The tube of claim 1, wherein the laser-sensitive, color-changing material is at least one of a mica-based pigment, DERUSSOL A, FW 200, an aluminum-based pigment, an oxyanion of a multivalent metal, ammonium octamolybdate, molybdenum trioxide, and MAXITHEN.

16. The tube of claim 9, wherein the tube is molded or blown.

17. The tube of claim 9, wherein the laser-sensitive, color-changing material is at least one of a mica-based pigment, DERUSSOL A, FW 200, an aluminum-based pigment, an oxyanion of a multivalent metal, ammonium octamolybdate, molybdenum trioxide, and MAXITHEN.

18. A method for identifying tubes, comprising:
pad printing a plurality of tubes with a mixture of ink and a laser sensitive material;
mounting a laser in translational relationship to a stage; and
translating at least one of the laser, a laser beam, and the stage relative to the others of the laser, the laser beam and the stage and in accordance with an identifier for each tube of the plurality of tubes in order to transform the laser-sensitive material on each tube from one color to another, wherein the transformation of the laser-sensitive material reveals the identifier.

19. The method of claim 18, wherein the plurality of tubes is placed into at least one rack on the stage, wherein the at least one rack normalizes a height of each tube of the plurality of tubes relative to a standard so that the laser-sensitive material on each tube is presented at a same distance from the laser regardless of a geometry of the tube.

20. The method of claim 19, wherein each tube of the plurality of tubes lays at least one of horizontally or vertically in the at least one rack.
